(19) United States
(12) Patent Application Publication
(10) Pub. No.: US 2016/0203091 A1
(43) Pub. Date: Jul. 14, 2016

(54) MEMORY CONTROLLER AND MEMORY SYSTEM INCLUDING THE SAME

(71) Applicant: SAMSUNG ELECTRONICS CO., LTD., Suwon-si (KR)

(72) Inventor: Tae-hack LEE, Hwaseong-si (KR)

(73) Assignee: SAMSUNG ELECTRONICS CO., LTD., Suwon-si (KR)

(21) Appl. No.: 14/959,467

(22) Filed: Dec. 4, 2015

(30) Foreign Application Priority Data
Jan. 13, 2015 (KR) 10-2015-0006121

(51) Int. Cl. G06F 13/16; G06F 13/40; G06F 3/06; G06F 13/42

(52) U.S. Cl. CPC G06F 13/1673; G06F 13/1642; G06F 13/4282; G06F 13/4068; G06F 3/061; G06F 3/0631; G06F 3/0683

(57) ABSTRACT

Provided are a memory controller that supports a host direct memory access (DMA) and a memory system including the memory controller. The memory system includes a memory and the memory controller configured to control the memory, wherein the memory controller may be connected to a host according to a bus standard, may fetch, from the host, a plurality of commands arranged according to a first order, and may complete, according to a second order, a plurality of operations corresponding to the plurality of commands.

### CROSS-REFERENCE TO RELATED APPLICATION

This application claims priority from Korean Patent Application No. 10-2015-0006121, filed on Jan. 13, 2015, in the Korean Intellectual Property Office, the disclosure of which is incorporated herein in its entirety by reference.

### BACKGROUND

1. Field

Apparatuses and methods consistent with exemplary embodiments relate to a memory controller and a memory system including the memory controller, and more particularly, to a memory controller that supports a host direct memory access (DMA) and a memory system including the memory controller.

2. Description of the Related Art

A volatile memory refers to a memory of which stored data is deleted when power is not supplied thereto, and a nonvolatile memory refers to a memory that retains stored data even if power is not supplied thereto. Recently, data storages, including a large-capacity volatile memory or a large-capacity nonvolatile memory, are widely used to store or transfer a large amount of data.

In order to reduce a time period taken to write data to a data storage or to read stored data from the data storage, a new interface for the data storage has been introduced. Thus, there is a demand for a data storage that is capable of writing and reading data at a faster speed.

### SUMMARY

One or more exemplary embodiments provide a memory controller for storing data in a memory or reading stored data from the memory by supporting a host direct memory access (DMA), and a memory system including the memory controller.

According to an aspect of an exemplary embodiment, there is provided a memory system including a memory and a memory controller configured to control the memory. The memory controller may include a first host interface connected to a host according to a bus standard; a host manager configured to fetch a first set of commands from the host via the first host interface; and a plurality of host direct memory access (DMA) engines, wherein each of the plurality of host DMA engines may control a transfer of user data corresponding to one of the first set of commands via the first host interface.

The memory controller may further include a host queue manager configured to allocate each command included in the first set of commands to one of the plurality of host DMA engines.

The memory controller may further include a resource monitor configured to monitor a load of each of the plurality of host DMA engines, and the host queue manager, based on a monitoring result by the resource monitor, may preferentially allocate the command included in the first set of commands to a host DMA engine that has a smallest load from among the plurality of host DMA engines.

The memory controller may further include a second host interface connected to the host according to the bus standard, the host manager may fetch a second set of commands from the host via the second host interface, and each of the plurality of host DMA engines may control a transfer of user data corresponding to one of the second set of commands via the second host interface.

The host manager may identify one of the first set of commands by using a first identifier and may identify one of the second set of commands by using a second identifier.

The memory controller may further include a buffer configured to temporarily store the user data, and the plurality of host DMA engines may control, independently from each other, a transfer of the user data between the first host interface and the buffer.

The first set of commands may be read commands for reading the user data, and each of the plurality of host DMA engines may determine whether the user data has been stored in the buffer, and may transmit the user data stored in the buffer to the host via the first host interface in response to determining that the user data has been stored in the buffer.

The first set of commands may be write commands for writing the user data, each of the plurality of host DMA engines may control the first host interface to receive the user data from the host, and may transmit the user data from the first host interface to the buffer.

The memory may include a plurality of memory devices each of which is connected to one of a plurality of channels, the memory controller may include a plurality of memory DMA engines that are connected to the plurality of channels, respectively, and each of the plurality of memory DMA engines may control a transfer of data between the buffer and at least one of the plurality of memory devices that is connected to the each of the plurality of memory DMA engines via a channel.

The memory controller may further include an internal bus to which the first host interface, the host manager, the plurality of host DMA engines, the buffer, and the plurality of memory DMA engines are connected.

The bus standard may be a Peripheral Component Interconnect Express (PCIe) standard.

According to an aspect of another exemplary embodiment, there is provided a memory system including a memory and a memory controller configured to control the memory. The memory controller may be connected to a host according to a bus standard, may fetch, from the host, a plurality of commands arranged according to a first order, and may complete, according to a second order, a plurality of operations corresponding to the plurality of commands.

When each of the plurality of operations is completed, the memory controller may transmit information about a command corresponding to a completed operation to the host.

The memory controller may include a plurality of host direct memory access (DMA) engines each of which is allocated to one of the plurality of commands.

According to an aspect of still another exemplary embodiment, there is provided a memory controller that controls a memory. The memory controller may include a first host interface connected to a host according to a bus standard; a host manager for fetching a first command and a second command from the host via the first host interface; a first host direct memory access (DMA) engine for controlling a transfer of first data via the first host interface, the first data corresponding to the first command; and a second host DMA engine for controlling a transfer of second data via the first host interface, the second data corresponding to the second command.

The memory controller may further include a host queue manager for allocating the first command and the second command to the first host DMA engine and the second host DMA engine, respectively.

The memory controller may further include a buffer for temporarily storing the first data and the second data, and the first host DMA engine and the second host DMA engine may control, independently from each other, a transfer of the first data and the second data between the first host interface and the buffer.

If the first command is a read command related to reading the first data, the first host DMA engine may check whether the first data has been stored in the buffer, and may transmit the first data stored in the buffer to the host via the first host interface after the first data has been stored in the buffer.

If the first command is a write command related to writing the first data, the first host DMA engine may control the first host interface to receive the first data from the host, and may transmits the first data from the first host interface to the buffer.

According to an aspect of still another exemplary embodiment, there is provided a memory controller for controlling a memory, the memory controller including: a first host direct memory access (DMA) engine configured to control a transfer of first data in response to a command to write or read the first data to/from the memory; and a second host DMA engine configured to control a transfer of second data in response to a command to write or read the second data to/from the memory such that the transfer of the second data is performed in parallel with the transfer of the first data.

The memory controller may further include a host interface connected to a host according to a bus standard; and a host manager configured to fetch a plurality of commands from the host via the host interface.

The memory controller may further include a buffer configured to temporarily store the first data and the second data, and the first host DMA engine and the second host DMA engine may independently control the transfer of the first data and the transfer of the second data between the host interface and the buffer.

The memory controller may further include a host queue manager configured to allocate a first command among a plurality of commands to the first DMA engine and allocate a second command among the plurality of commands to the second DMA engine.

An order in which the first command and the second command are arranged may be different from an order in which the transfer of the first data and the transfer of the second data are completed by the first and second host DMA engines, respectively.

### BRIEF DESCRIPTION OF THE DRAWINGS

The above and/or other aspects will become more apparent by describing certain exemplary embodiments with reference to the accompanying drawings in which:

FIG. 1 illustrates a memory system including a memory controller according to an exemplary embodiment;

FIG. 2 illustrates a memory controller according to an exemplary embodiment;

FIG. 3 illustrates a memory system including a memory controller, according to another exemplary embodiment;

FIG. 4 illustrates a structure of a queue memory of FIG. 3, according to an exemplary embodiment;

FIG. 5 illustrates a memory system including a memory controller, according to another exemplary embodiment;

FIGS. 6A and 6B illustrate operations of the memory controller of FIG. 5, wherein the operations correspond to first through fifth read commands;

FIGS. 7A and 7B illustrate operations of the memory controller of FIG. 5, wherein the operations correspond to first through fifth write commands;

FIG. 8 illustrates a flowchart showing operations of the memory controller, according to an exemplary embodiment;

FIGS. 9 and 10 illustrate flowcharts showing operations of a host direct memory access (DMA) engine, according to exemplary embodiments;

FIG. 11 illustrates a memory card according to an exemplary embodiment; and

FIG. 12 illustrates a computing system including a nonvolatile storage, according to an exemplary embodiment.

### DETAILED DESCRIPTION

Exemplary embodiments of the inventive concept will now be described more fully with reference to the accompanying drawings, in which exemplary embodiments of the inventive concept are shown. The inventive concept may, however, be embodied in many different forms, and should not be construed as being limited to the embodiments set forth herein; rather, these embodiments are provided so that this disclosure will be thorough and complete, and will fully convey the inventive concept to those skilled in the art. Thus, the inventive concept may include all revisions, equivalents, or substitutions which are included in the idea and the technical scope related to the inventive concept. Like reference numerals in the drawings denote like elements. In the drawings, the dimension of structures may be exaggerated for clarity.

Furthermore, all examples and conditional language recited herein are to be construed as being without limitation to such specifically recited examples and conditions. Throughout the specification, a singular form may include plural forms, unless there is a particular description contrary thereto. Also, terms such as “comprise” or “comprising” are used to specify existence of a recited form, a number, a process, an operation, a component, and/or groups thereof, not excluding the existence of one or more other recited forms, one or more other numbers, one or more other processes, one or more other operations, one or more other components and/or groups thereof.

Unless expressly described otherwise, all terms including descriptive or technical terms which are used herein should be construed as having meanings that are obvious to one of ordinary skill in the art. Also, terms that are defined in a general dictionary and that are used in the following description should be construed as having meanings that are equivalent to meanings used in the related description, and unless expressly described otherwise herein, the terms should not be construed as being ideal or excessively formal

As used herein, the term “and/or” includes any and all combinations of one or more of the associated listed items. Expressions such as “at least one of,” when preceding a list of elements, modify the entire list of elements and do not modify the individual elements of the list.

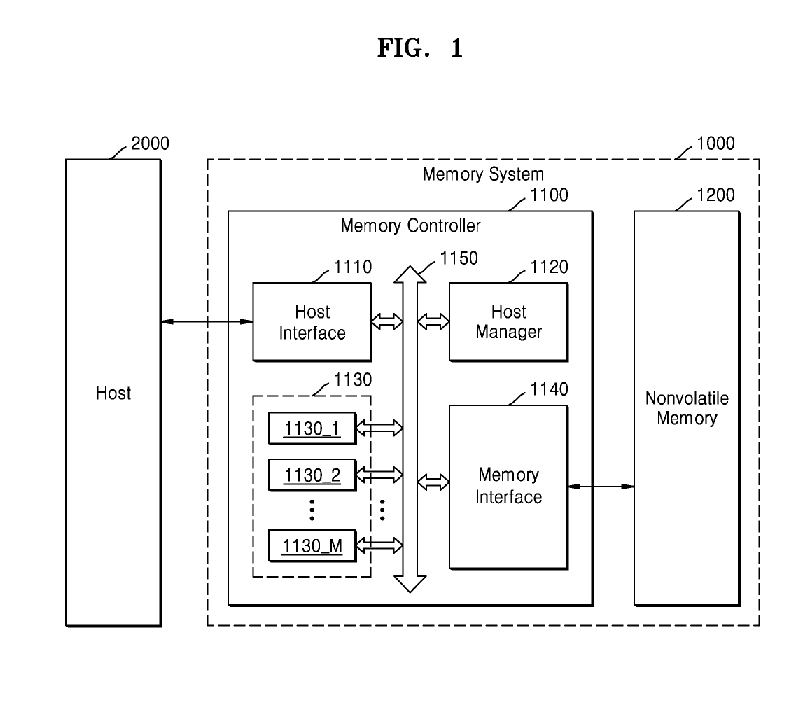

FIG. 1 illustrates a memory system 1000 including a memory controller 1100 according to an exemplary embodiment. As illustrated in FIG. 1, the memory system 1000 may communicate with a host 2000 via the memory controller 1100, and may include a nonvolatile memory 1200 and the memory controller 1100 for controlling the nonvolatile memory 1200. The host 2000 may generate at least one command for instructing the memory system 1000 to perform a certain operation, and the memory system 1000 may perform the certain operation, in response to the command generated by the host 2000. For example, the host 2000 may generate a command for writing data to the memory system 1000 or a command for reading data from the memory system 1000. Hereinafter, data that the host 2000 writes to the memory system 1000 and/or data that the host 2000 reads from the memory system 1000 may be referred to as user data. The user data may be different from metadata that is autonomously generated by the memory controller 1100 to manage the user data. The memory system 1000 and the host 2000 may be connected to each other according to a bus standard, e.g., a peripheral component interconnect express (PCIe). Also, the memory system 1000 and the host 2000 may exchange a command and/or data according to a communication protocol including, but is not limited to, serial advanced technology attachment (SATA), small computer system interface express (SCSIe), non-volatile memory express (NVMe), embedded Multi Media Card (eMMC), or secure digital (SD).

The nonvolatile memory 1200 may include a memory or a memory device capable of retaining stored data even if power is not supplied thereto. Thus, even if power supplied to the memory system 1000, e.g., power received from the host 2000 is discontinued, data stored in the nonvolatile memory 1200 may be retained. The nonvolatile memory 1200 may include, but is not limited to, a NAND flash memory, a vertical NAND (VNAND) flash memory, a NOR flash memory, a resistive random access memory (RRAM), a phase-change memory (PRAM), a magnetoresistive random access memory (MRAM), a ferroelectric random access memory (FRAM), a spin transfer torque random access memory (STT-RAM), or the like.

The nonvolatile memory 1200 may have a three-dimensional (3D) array structure. Also, the nonvolatile memory 1200 may include a semiconductor memory device and/or a magnetic disc device. One or more exemplary embodiments may be applied to all of a flash memory in which a charge storage layer is formed as a conductive floating gate, and a charge trap flash (CTF) memory in which a charge storage layer is formed as an insulting layer. Hereinafter, for convenience of description, it is assumed that the nonvolatile memory 1200 is a NAND flash memory, but one or more exemplary embodiments are not limited thereto.

In an exemplary embodiment, a three dimensional (3D) memory array is provided. The 3D memory array is monolithically formed in one or more physical levels of arrays of memory cells having an active area disposed above a silicon substrate and circuitry associated with the operation of those memory cells, whether such associated circuitry is above or within such substrate. The term “monolithic” means that layers of each level of the array are directly deposited on the layers of each underlying level of the array.

In an exemplary embodiment, the 3D memory array includes vertical NAND strings that are vertically oriented such that at least one memory cell is located above another memory cell. The at least one memory cell may comprise a charge trap layer.

The following patent documents, which are hereby incorporated by reference, describe suitable configurations for three-dimensional memory arrays, in which the three-dimensional memory array is configured as a plurality of levels, with word lines and/or bit lines shared between levels: U.S. Pat. Nos. 7,679,133; 8,553,466; 8,654,587; 8,559,235; and US Pat. Pub. No. 2011/0233648.

Referring to FIG. 1, a memory that is controlled by the memory controller 1100 is illustrated as the nonvolatile memory 1200. However, one or more exemplary embodiments are not limited to the exemplary embodiment of FIG. 1, and, in some exemplary embodiments, the memory system 1000 may include a volatile memory, and the memory controller 1100 may control the volatile memory. The volatile memory may include, for example, a dynamic random access memory (DRAM), a static random access memory (SRAM), or the like.

As illustrated in FIG. 1, the memory controller 1100 (also referred to as a controller 1100) of the memory system 1000 may include a host interface 1110, a host manager 1120, a plurality of host direct memory access (DMA) engines 1130, and a memory interface 1140. The host interface 1110, the host manager 1120, the host DMA engines 1130, and the memory interface 1140 may be connected to an internal bus 1150, and may transmit and/or receive a signal via the internal bus 1150.

The memory controller 1100 may receive a command and/or data from the host 2000 and/or may transmit data to the host 2000. For example, the host manager 1120 may fetch a command from the host 2000 via the host interface 1110, and the host DMA engines 1130 may transmit data to the host 2000 by transferring the data to the host interface 1110. The host interface 1110 may support a memory mapped serial interface, e.g., a PCIe or a low latency interface (LLI). Also, the memory controller 1100 may transmit data to the nonvolatile memory 1200 and/or may read data from the nonvolatile memory 1200 via the memory interface 1140.

The host manager 1120 may fetch a plurality of commands from the host 2000 via the host interface 1110. For example, the host manager 1120 may include a register, and the host 2000 may update the register included in the host manager 1120 via the host interface 1110. When the register is updated by the host 2000, the host manager 1120 may fetch a plurality of commands from a command queue (or a submission queue) included in the host 2000 via the host interface 1110. Each of the plurality of commands fetched by the host manager 1120 may instruct the memory system 1000 to write data to the nonvolatile memory 1200 and/or to read stored data from the nonvolatile memory 1200.

In some exemplary embodiments, the memory controller 1100 may include the host DMA engines 1130. For example, as illustrated in FIG. 1, the memory controller 1100 may include a first through an M-th host DMA engines 1130_1, 1130_2, . . . , 1130_M. Each of the host DMA engines 1130 may independently control a transfer of data via the host interface 1110. That is, each of the host DMA engines 1130 may independently control a transfer of data, corresponding to one of the plurality of commands fetched by the host manager 1120, via the host interface 1110. For example, the first host DMA engine 1130_1 may independently control a transfer of data corresponding to a first command via the host interface 1110, and the second host DMA engine 1130_2 may independently control a transfer of data corresponding to a second command via the host interface 1110.

If the first command is a read command, the first host DMA engine 1130_1 may control, independently from the second host DMA engine 1130_2, to transmit the data corresponding to the first command, i.e., data to be read by the host 2000, to the host interface 1110, and thus the data may be transmitted to the host 2000. If the first command is a write command, the first host DMA engine 1130_1 may control, independently from the second host DMA engine 1130_2, to receive the data corresponding to the first command, i.e., data to be written by the host 2000, from the host interface 1110.

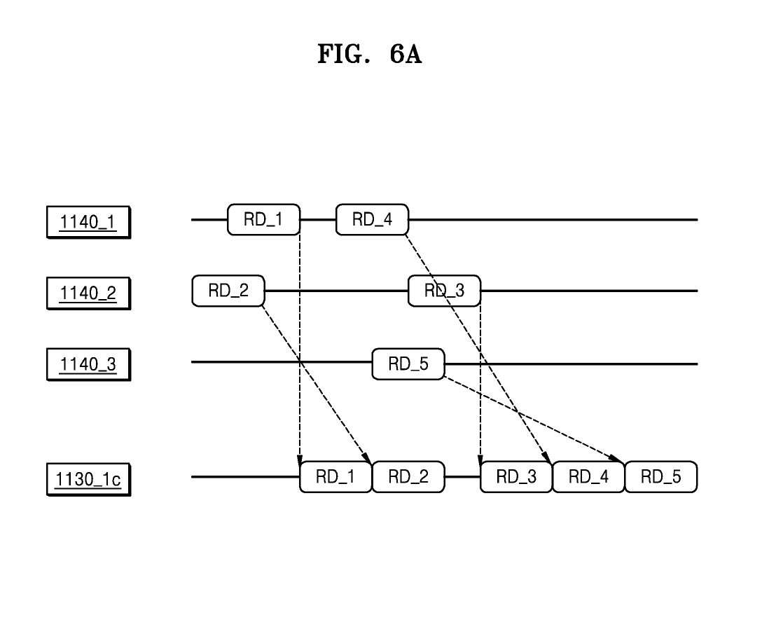

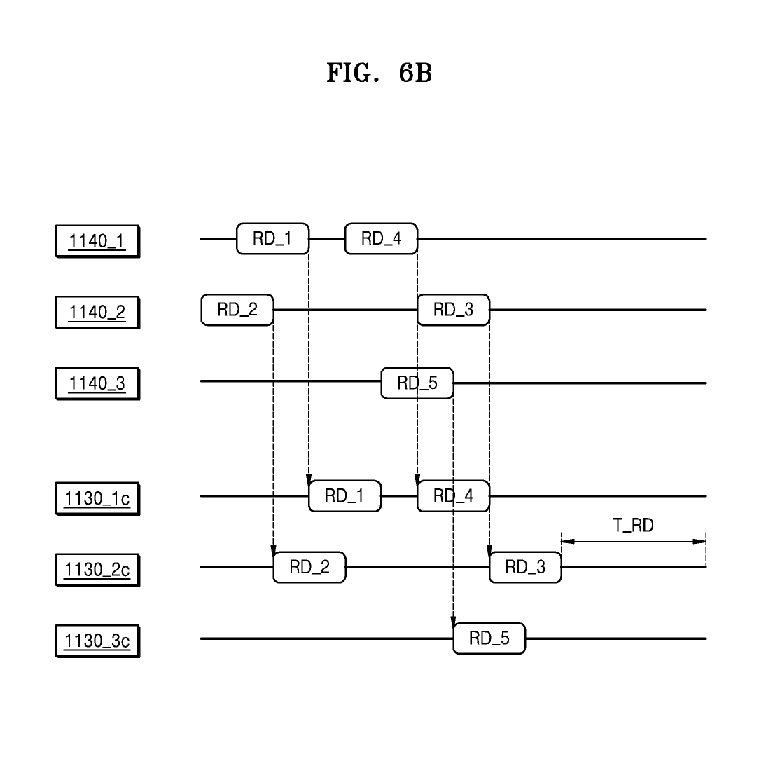

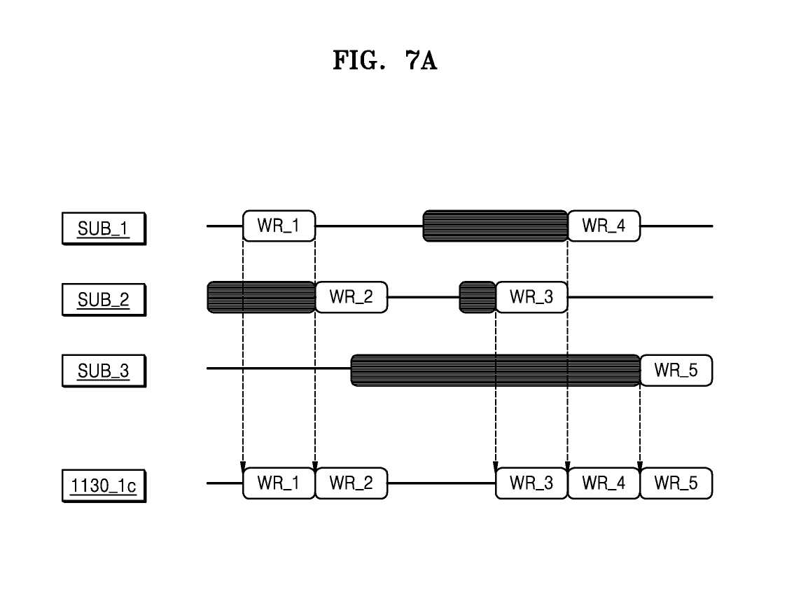

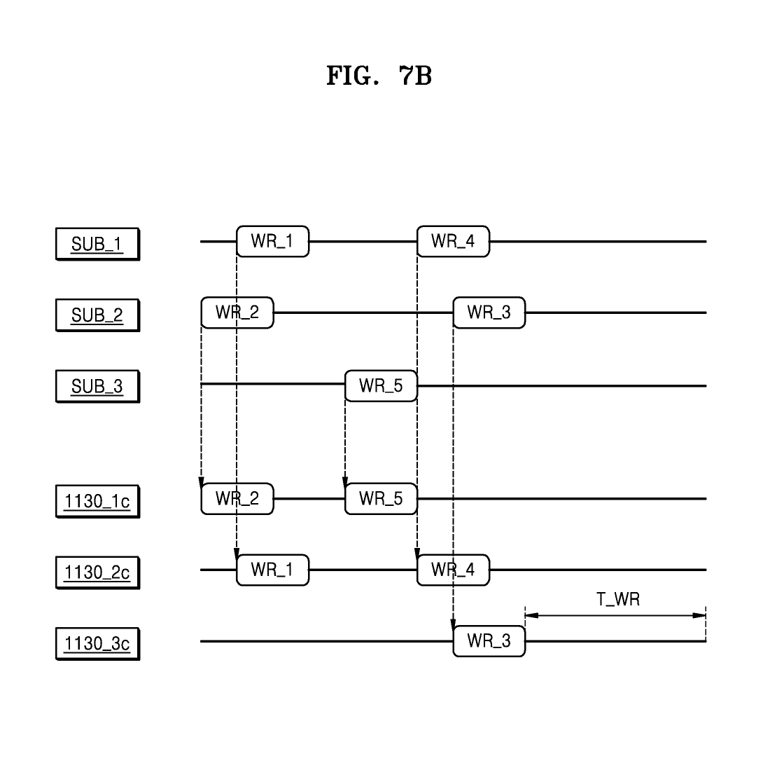

In some exemplary embodiments, a protocol used to connect the memory system 1000 and the host 2000 may support provision of a plurality of commands. For example, NVMe or SCSIe that is a PCIe storage protocol may support provision of a plurality of commands, so that DMA operations that respectively correspond to the plurality of commands may be processed in parallel or may be completed in an order that is different from those of the plurality of commands. For example, the host manager 1120 may fetch a plurality of commands arranged in a first order from the host 2000 via the host interface 1110. Each of the host DMA engines 1130 may be allocated to one of the plurality of commands, and may perform, independently from each other, operations corresponding to the allocated commands. Accordingly, the operations corresponding to the plurality of commands may be completed in a second order that may be equal to or different from the first order. For example, since the memory controller 1100 includes the host DMA engines 1130, operations corresponding to a plurality of fetched commands may be performed in parallel, so that a total response time of the plurality of commands generated by the host 2000 may be reduced. Operations by the host DMA engines 1130 will be described in detail with reference to FIGS. 6A, 6B, 7A, and 7B.

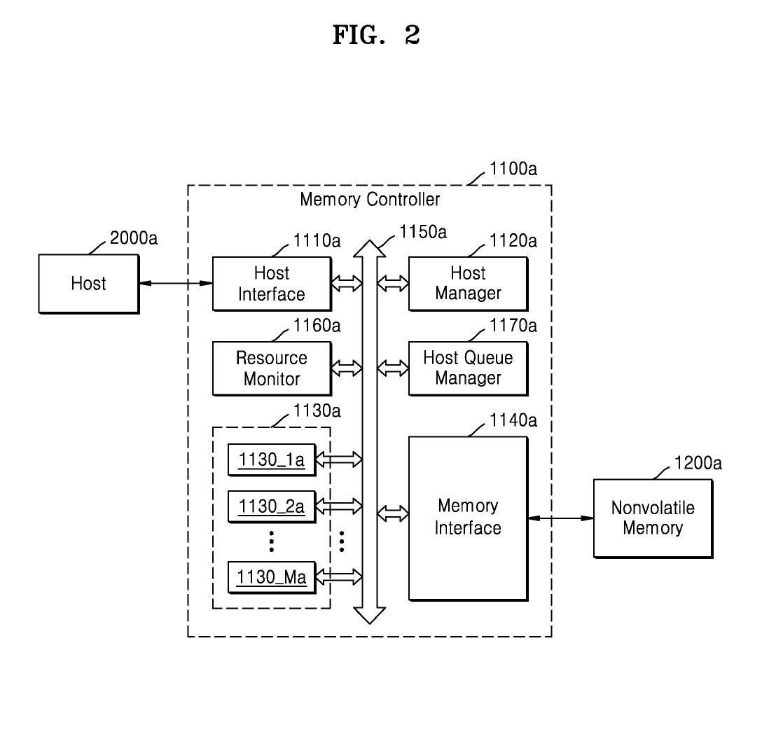

FIG. 2 illustrates a memory controller 1100a according to an exemplary embodiment. Similar to the memory controller 1100 of FIG. 1, the memory controller 1100a may be connected to a host 2000a and a nonvolatile memory 1200a. The memory controller 1100a may include a host interface 1110a, a host manager 1120a, a plurality of host DMA engines 1130a, a memory interface 1140a, and an internal bus 1150a. The host interface 1110a, the host manager 1120a, the plurality of host DMA engines 1130a, the memory interface 1140a, and the internal bus 1150a may perform functions that are same as or similar to functions of their corresponding elements shown in FIG. 1.

As illustrated in FIG. 2, the memory controller 1100a may include a resource monitor 1160a and a host queue manager 1170a. The resource monitor 1160a may monitor a load of each of the host DMA engines 1130a. For example, the resource monitor 1160a may monitor each of commands (or each of operations corresponding to the commands) that are allocated to the host DMA engines 1130a, respectively, or may monitor a size of data corresponding to an allocated command.

Based on a result of monitoring of the host DMA engines 1130a by the resource monitor 1160a, the host queue manager 1170a may allocate each of a plurality of commands fetched by the host manager 1120a (or operation corresponding to each of the plurality of commands) to one of the host DMA engines 1130a. For example, the host queue manager 1170a may recognize the load of each of the host DMA engines 1130a from the resource monitor 1160a, and may preferentially allocate a command to a host DMA engine that has a smallest load from among the host DMA engines 1130a. Therefore, the operations corresponding to the plurality of commands may be performed in parallel, and thus may be quickly completed.

Referring to FIG. 2, the host manager 1120a, the resource monitor 1160a, and the host queue manager 1170a are illustrated as independent elements that are connected to the internal bus 1150a. However, in some exemplary embodiments, some or all of the host manager 1120a, the resource monitor 1160a, and the host queue manager 1170a may be software blocks that are executed by a single hardware element, e.g., single processor. Also, each of the host manager 1120a, the resource monitor 1160a, and the host queue manager 1170a may be an individual processor or an individual digital circuit including a plurality of logic gates.

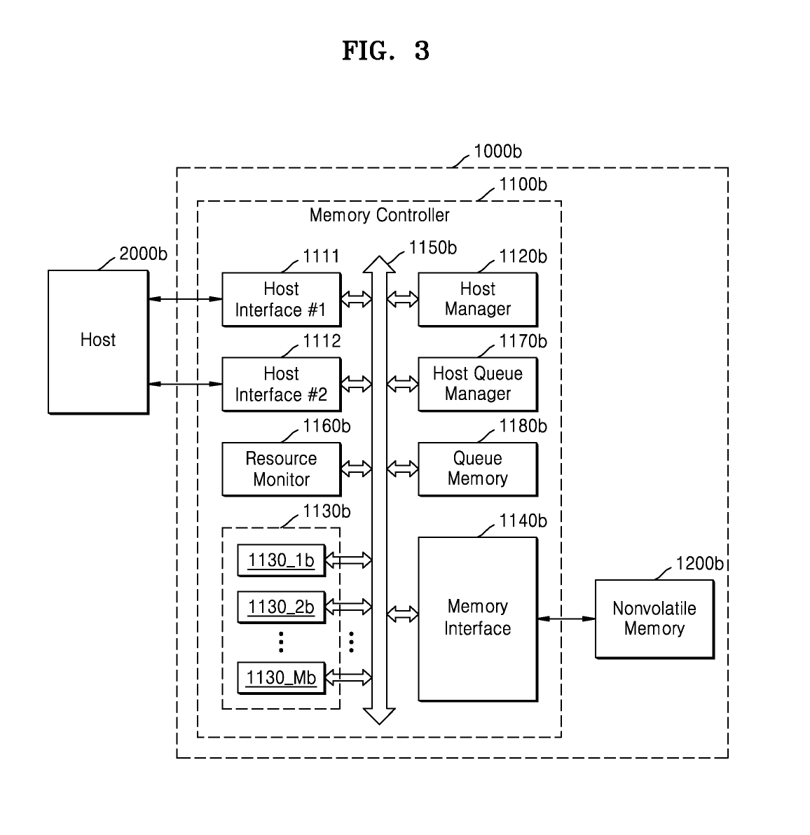

FIG. 3 illustrates a memory system 1000b including a memory controller 1100b, according to another exemplary embodiment. In the exemplary embodiment of FIG. 3, the memory system 1000b (or the memory controller 1110b) may include at least two ports to be connected to a host 2000b. For example, if the host 2000b such as a server needs a high data transmission speed and stability, the host 2000b and the memory system 1000b may be connected to each other via a plurality of ports. The ports may be independent from each other to perform a data transfer. For example, to overcome an error such as a failover that occurs in a port, the host 2000b and the memory system 1000b may have a plurality of ports.

As illustrated in FIG. 3, the memory controller 1100b may be connected to the host 2000b via two ports, and may include a first host interface 1111 and a second host interface 1112 that correspond to the two ports, respectively. A host manager 1120b may fetch a plurality of commands via each of the first and second host interfaces 1111 and 1112. For example, the host manager 1120b may fetch a first set of commands from the first host interface 1111 and may fetch a second set of commands from the second host interface 1112. To allow the memory system 1000b to properly respond to the fetched commands, the host manager 1120b may identify the fetched commands, according to the first and second host interfaces 1111 and 1112. For example, the host manager 1120b may add a first identifier to the first set of commands and may add a second identifier to the second set of commands. The host manager 1120b may store, in a queue memory 1180b, the first set of commands and the second set of commands to which the first and second identifiers are respectively added.

A resource monitor 1160b may monitor a load of each of a plurality of host DMA engines 1130b, and based on a result of monitoring of the host DMA engines 1130b by the resource monitor 1160b, a host queue manager 1170b may allocate each of a plurality of commands, e.g., a command included in first set of commands and second set of commands, to one of the host DMA engines 1130b. For example, the host queue manager 1170b may read a plurality of commands that are stored in the queue memory 1180b by the host manager 1120b, may allocate each of the plurality of commands to one of the host DMA engines 1130b based on a result of monitoring of the host DMA engines 1130b by the resource monitor 1160b, and may store, in the queue memory 1180b, information about the host DMA engines 1130b to which the plurality of commands are respectively allocated.

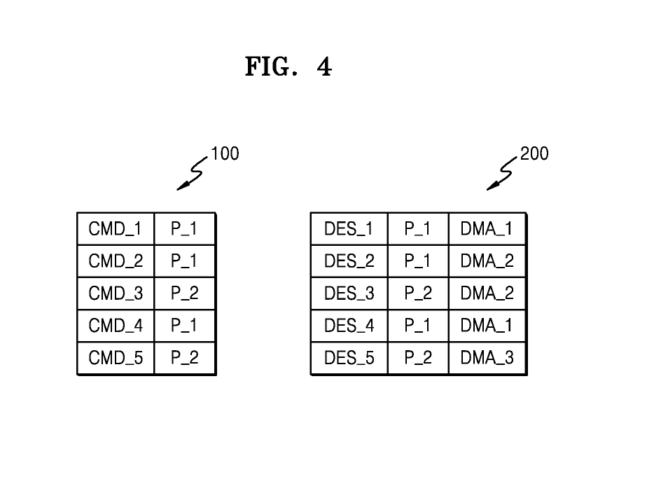

FIG. 4 illustrates a structure of the queue memory 1180b of FIG. 3, according to an exemplary embodiment. Referring to FIGS. 3 and 4, the queue memory 1180b may store information about the host DMA engines 1130b that are respectively allocated to the plurality of commands to which the host manager 1120b has added an identifier and the plurality of commands to which the host queue manager 1170b has added an identifier. The queue memory 1180b may include a DRAM or an SRAM.

As illustrated in FIG. 4, the queue memory 1180b may include a command queue 100 and a DMA queue 200. The command queue 100 may store a plurality of commands to which an identifier has been added. For example, the command queue 100 may store commands CMD_1, CMD_2, and CMD_4, to which a first identifier P_1 has been added, that are received via the first host interface 1111, and may store commands CMD_3 and CMD_5, to which a second identifier P_2 has been added, that are received via the second host interface 1112. The first and second identifiers P_1 and P_2 indicate the first and second host interfaces 1111 and 1112, respectively, and may be used in determining a target host interface via which data is transferred when a host DMA engine 1130b controls a transfer of data.

The DMA queue 200 may store information about the host DMA engine 1130b that is allocated to a command. For example, the host queue manager 1170b may generate a plurality of descriptors indicating operations that correspond to the plurality of commands, respectively. As illustrated in FIG. 4, the plurality of descriptors may include at least one from among a descriptor (e.g., DES_1) indicating an operation that corresponds to a command, a descriptor (e.g., P_1) indicating the first or second host interface 1111 or 1112, and a descriptor (e.g., DMA_1) indicating information about the host DMA engine 1130b. The host queue manager 1170b may store the generated descriptors in the DMA queue 200 of the queue memory 1180b.

In an exemplary embodiment, reading queue data from the queue memory 1180b may be performed by using a doorbell method. For example, the queue memory 1180b may include a command queue doorbell and a DMA queue doorbell that correspond to the command queue 100 and the DMA queue 200, respectively. The host manager 1120b may add an identifier to a fetched command and may store the identifier and the fetched command in the command queue 100, and the host manager 1120b may update the command queue doorbell accordingly. The host queue manager 1170b may check the command queue doorbell, for example by polling, and when the host manager 1120b updates the command queue doorbell, the host queue manager 1170b may recognize the update, and thus may read a plurality of commands and identifiers stored in the command queue 100.

Similarly, the host queue manager 1170b may store the generated descriptors in the DMA queue 200, and when a storing operation is completed, the host queue manager 1170b may update the DMA queue doorbell. Each of the host DMA engines 1130b may check the DMA queue doorbell, for example by polling, and when the host queue manager 1170b updates the DMA queue doorbell, each of the host DMA engines 1130b may recognize a descriptor allocated thereto and may read the descriptors from the DMA queue 200.

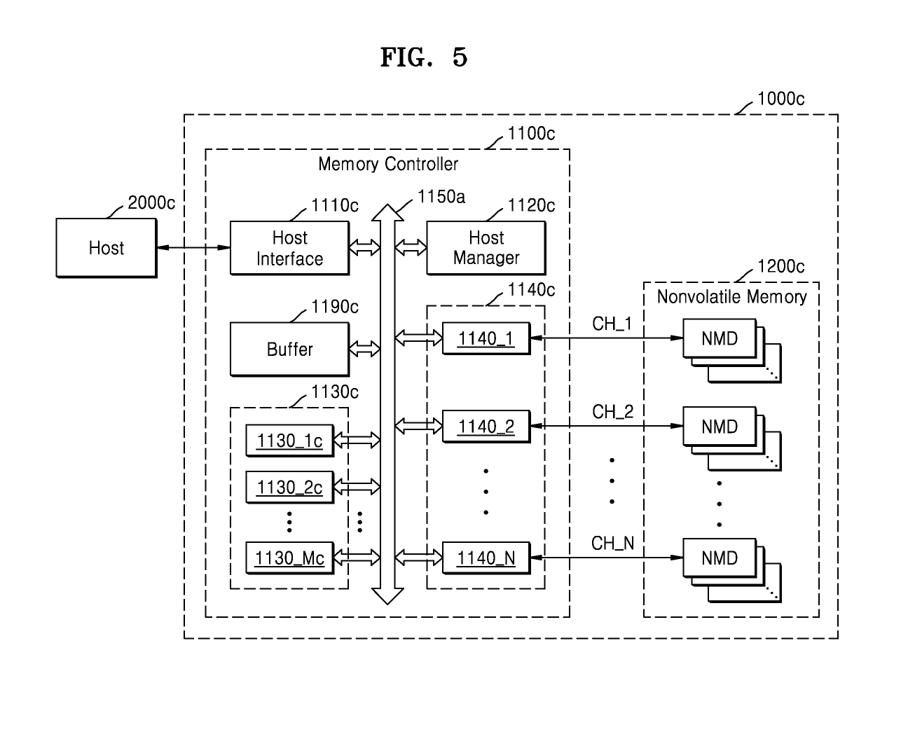

FIG. 5 illustrates a memory system 1000c including a memory controller 1100c, according to another exemplary embodiment. Similar to the memory controller 1100 of FIG. 1, the memory controller 1100c of the memory system 1000c may be connected to a host 2000c and a nonvolatile memory 1200c, and may include a host interface 1110c, a host manager 1120c, and a plurality of host DMA engines 1130c.

The host interface 1110c, the host manager 1120c, and the plurality of host DMA engines 1130c may perform functions that are same as or similar to functions of their corresponding elements shown in FIG. 1.

In the exemplary embodiment of FIG. 5, the memory controller 1100c may include a buffer 1190c. The buffer 1190c may include a memory such as a DRAM or an SRAM, and may temporarily store data to be written to the nonvolatile memory 1200c or data that is read from the nonvolatile memory 1200c. For example, data that is read from the nonvolatile memory 1200c according to a read command received from the host 2000c may be temporarily stored in the buffer 1190c, and the data stored in the buffer 1190c may be transmitted to the host 2000c via the host interface 1110c under a control of one of the host DMA engines 1130c. Also, data that is received from the host 2000c via the host interface 1110c according to a write command received from the host 2000c may be temporarily stored in the buffer 1190c under a control of one of the host DMA engines 1130c. That is, each of the host DMA engines 1130c may independently control a transfer of data between the host interface 1110c and the buffer 1190c.

In an exemplary embodiment, the nonvolatile memory 1200c may include a plurality of nonvolatile memory devices NMD, and each of the nonvolatile memory devices NMD may be connected to one of a plurality of channels. For example, as illustrated in FIG. 5, each of the nonvolatile memory devices NMD may be connected to one of N channels CH_1, CH_2, . . . , CH_N. A memory interface 1140c may include N memory DMA engines 1140_1, 1140_2, . . . , 1140_N, and the memory DMA engines 1140_1, 1140_2, . . . , 1140_N may be connected to the nonvolatile memory devices NMD via the channels CH_1, CH_2, . . . , CH_N, respectively. Each of the memory DMA engines 1140_1, 1140_2, . . . , 1140_N may independently control a transfer of data between the buffer 1190c and the nonvolatile memory devices NMD.

In an exemplary embodiment, the buffer 1190c may include a descriptor indicating whether a data storing operation is completed. For example, if a command allocated to a first host DMA engine 1130_1c is a read command, the first host DMA engine 1130_1c may check whether the data storing operation is completed by checking the descriptor included in the buffer 1190c, and thus may independently transmit data stored in the buffer 1190c to the host interface 1110c, without assistance from another element, e.g., a host queue manager 1170c of FIG. 3.

FIGS. 6A and 6B illustrate operations of the memory controller 1100c of FIG. 5, wherein the operations correspond to first through fifth read commands CMD_1 through CMD_5. FIG. 6A illustrates an operation of the memory controller 1100c when only one of the host DMA engines 1130c is used, and FIG. 6B illustrates an operation of the memory controller 1100c when three host DMA engines 1130c are used. In examples shown in FIGS. 6A and 6B, the first through fifth read commands CMD_1 through CMD_5 are sequentially read by the host manager 1120c in an order from the first read command CMD_1 to the fifth read command CMD_5, and pieces of data RD_1 through data RD_5 correspond to the first through fifth read commands CMD_1 through CMD_5, respectively.

In the examples shown in FIGS. 6A and 6B, a first through a third memory DMA engines 1140_1, 1140_2, and 1140_3 may read in parallel a plurality of pieces of corresponding data from the nonvolatile memory devices NMD via channels to which the memory DMA engines 1140_1, 1140_2, and 1140_3 are connected, respectively, and may store the plurality of pieces of corresponding data in the buffer 1190c. For example, the second memory DMA engine 1140_2 may store the data RD_2 corresponding to the second read command CMD_2 in the buffer 1190c, and after an elapse of a preset time period, the second memory DMA engine 1140_2 may store the data RD_3 corresponding to the third command CMD_3 in the buffer 1190c. As illustrated in FIGS. 6A and 6B, the first through third memory DMA engines 1140_1, 1140_2, and 1140_3 may start or complete operations allocated thereto, at different time points according to an amount of data that is set to be processed or according to a response time of the nonvolatile memory devices NMD.

As illustrated in FIG. 6A, in a case where only the first host DMA engine 1130_1c from among the host DMA engines 1130c is used, all data may be sequentially transmitted to the host 2000c via the host interface 1110c, according to an order in which a plurality of commands are arranged. That is, the first host DMA engine 1130_1c may be controlled to sequentially perform the first through fifth read commands CMD_1 through CMD_5 in an order from the first read command CMD_1 to the fifth read command CMD_5. Thus, the data RD_1 through data RD_5 may be sequentially transmitted in an order from the data RD_1 to the data RD_5 to the host 2000c via the host interface 1110c.

As described above, since the first through third memory DMA engines 1140_1, 1140_2, and 1140_3 may store data in the buffer 1190c at different time points, as illustrated in FIG. 6A, even if the second memory DMA engine 1140_2 has completed storing the data RD_2 corresponding to the second read command CMD_2 in the buffer 1190c, the first host DMA engine 1130_1c may wait until the first memory DMA engine 1140_1 stores the data RD_1 corresponding to the first read command CMD_1 in the buffer 1190c. Accordingly, an unwanted delay may occur, such that a response time with respect to a read command from the host 2000c may be increased.

As illustrated in FIG. 6B, in a case where a plurality of host DMA engines, i.e., the first through third host DMA engines 1130_1c, 1130_2c, and 1130_3c are used, a plurality of pieces of corresponding data may be transmitted in parallel to the host 2000c via the host interface 1110c. For example, the first host DMA engine 1130_1c may be allocated to the first and fourth read commands CMD_1 and CMD_4, the second host DMA engine 1130_2c may be allocated to the second and third read commands CMD_2 and CMD_3, and the third host DMA engine 1130_3c may be allocated to the fifth read command CMD_5. Accordingly, each of the first through third host DMA engines 1130_1c, 1130_2c, and 1130_3c may independently check whether data corresponding to a command has been completely stored in the buffer 1190c, and when the data has been completely stored, each of the first through third host DMA engines 1130_1c, 1130_2c, and 1130_3c may independently transmit the data stored in the buffer 1190c to the host 2000c via the host interface 1110c. For example, when the data RD_1 corresponding to the first read command CMD_1 is stored in the buffer 1190c, the first host DMA engine 1130_1c may transmit the data RD_1 from the buffer 1190c to the host 2000c via the host interface 1110c. The data RD_1 through the data RD_5 may be transmitted in parallel to the host 2000c, therefore, a time period taken to complete operations corresponding to all of the first through fifth read commands CMD_1 through CMD_5 in the example of FIG. 6B may be decreased by a time interval T_RD, compared to the example of FIG. 6A.

When each operation corresponding to each command is completed, the memory controller 1100c may transmit, to the host 2000c, information about the command that corresponds to the completed operation. For example, when each of the first through third host DMA engines 1130_1c, 1130_2c, and 1130_3c completes an operation according to an allocated command, each of the first through third host DMA engines 1130_1c, 1130_2c, and 1130_3c may transmit information about the allocated command to the host 2000c via the host interface 1110c. That is, when the first host DMA engine 1130_1c completes storing data RD_1 in the buffer 1190c, the first host DMA engine 1130_1c may transmit information about a first command CMD_1 to the host 2000c via the host interface 1110c. As another example, the host manager 1120c may check whether each of the first through third host DMA engines 1130_1c, 1130_2c, and 1130_3c has completed an operation according to an allocated command, and when the operation has been completed, the host manager 1120c may transmit information about the allocated command corresponding to the completed operation, to the host 2000c via the host interface 1110c. Based on the information about the allocated command received from the memory controller 1100c, the host 2000c may recognize the completed command from among a plurality of commands.

FIGS. 7A and 7B illustrate operations of the memory controller 1100c of FIG. 5, wherein the operations correspond to a first through a fifth write commands CMD_1 through CMD_5. FIG. 7A illustrates an operation of the memory controller 1100c when only one of the host DMA engines 1130c is used, and FIG. 7B illustrates an operation of the memory controller 1100c when three host DMA engines 1130c are used. In examples shown in FIGS. 7A and 7B, the first through fifth write commands CMD_1 through CMD_5 are sequentially read by the host manager 1120c in an order from the first write command CMD_1 to the fifth write command CMD_5, and data WR_1 through data WR_5 correspond to the first through fifth write commands CMD_1 through CMD_5, respectively.

In the examples shown in FIGS. 7A and 7B, the host 2000c may include a plurality of sub-systems, i.e., first through third sub-systems SUB_1, SUB_2, and SUB_3 that are connected to the memory system 1000c according to a bus standard. According to a plurality of write commands generated by a processor or a DMA controller included in the host 2000c, data that is stored in or is generated by each of the first through third sub-systems SUB_1, SUB_2, and SUB_3 may be transmitted to the memory system 1000c and may be written to the nonvolatile memory 1200c included in the memory system 1000c. Time points at which the data are transmitted to the memory system 100c from the first through third sub-systems SUB_1, SUB_2, and SUB_3 may be different from each other according to statuses of the first through third sub-systems SUB_1, SUB_2, and SUB_3. For example, when each of the first through third sub-systems SUB_1, SUB_2, and SUB_3 performs a particular operation having a high priority, or generates data to be transmitted to the memory system 1000c, a time point for each of the first through third sub-systems SUB_1, SUB_2, and SUB_3 to transmit the data to the memory system 1000c may be delayed by a difference between the time points. In example of FIG. 7A, shadow portions indicate states in which each of the first through third sub-systems SUB_1, SUB_2, and SUB_3 is capable of transmitting data.

As illustrated in FIG. 7A, when only the first host DMA engine 1130_1c from among the host DMA engines 1130c is used, all of data may be sequentially transmitted to the memory system 1000c, according to an order in which a plurality of commands are arranged. That is, the first host DMA engine 1130_1c may be controlled to sequentially perform the first through fifth write commands CMD_1 through CMD_5 in an order from the first write command CMD_1 to the fifth write command CMD_5. Thus, the data RD_1 through data RD_5 may be sequentially transmitted in an order from the data RD_1 to the data RD_5 to memory system 1000c and may be stored in the buffer 1190c via the host interface 1110c. As described above, the first through third sub-systems SUB_1, SUB_2, and SUB_3 may transmit data at different time points according to states thereof. Accordingly, as illustrated in FIG. 7A, even if the second sub-system SUB_2 is capable of transmitting the data WR_2 corresponding to the second write command CMD_2, the first host DMA engine 1130_1c may wait until the first sub-system SUB_1 transmits the data WR_1 corresponding to the first write command CMD_1. Accordingly, an unwanted delay may occur, such that a response time to a write command from the host 2000c may be increased.

As illustrated in FIG. 7B, in a case where a plurality of host DMA engines, i.e., the first through third host DMA engines 1130_1c, 1130_2c, and 1130_3c are used, a plurality of pieces of corresponding data may be transmitted in parallel from the first through third sub-systems SUB_1, SUB_2, and SUB_3 to the memory system 1000c. For example, the first host DMA engine 1130_1c may be allocated to the second and fifth write commands CMD_2 and CMD_5, the second host DMA engine 1130_2c may be allocated to the first and fourth write commands CMD_1 and CMD_4, and the third host DMA engine 1130_3c may be allocated to the third write command CMD_3. Therefore, the first through third host DMA engines 1130_1c, 1130_2c, and 1130_3c may independently control to receive data via the host interface 1110c from the first through third sub-systems SUB_1, SUB_2, and SUB_3 that are included in the host 2000c, and may independently store the received data in the buffer 1190c. For example, the second host DMA engine 1130_2c may control to receive the data WR_1 corresponding to the first write command CMD_1 via the host interface 1110c from the first sub-system SUB_1, and may store the received data WR_1 in the buffer 1190c. The data WR_1 through the data WR_5 may be transmitted in parallel to the memory system 1000c, and therefore, a time period taken to complete operations corresponding to all of the first through fifth write commands CMD_1 through CMD_5 may be decreased by a time interval T_WR in the example of FIG. 7B, compared to the example of FIG. 7A.

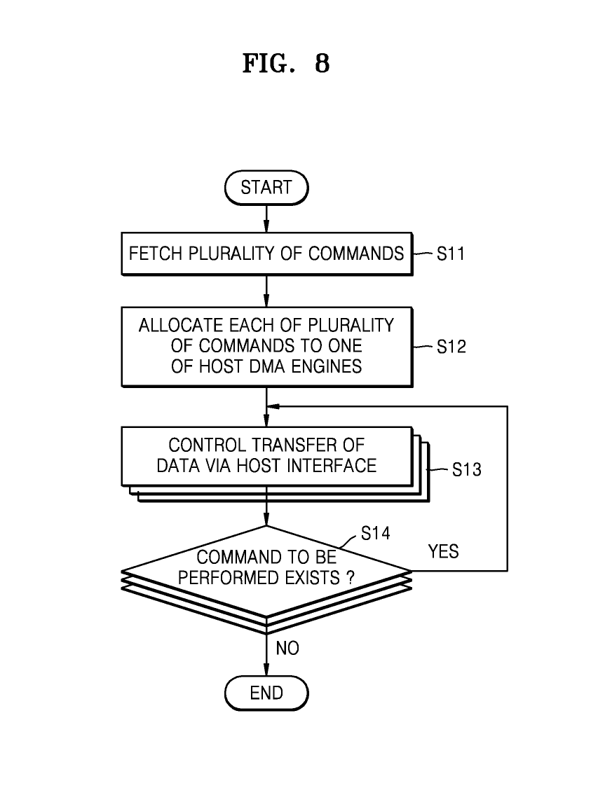

FIG. 8 illustrates a flowchart showing operations of the memory controller 1100a, according to an exemplary embodiment. Referring to FIGS. 2 and 8, the host manager 1120a included in the memory controller 1100a may fetch a plurality of commands arranged according to a first order from the host 2000a via the host interface 1110a (S11). The host queue manager 1170a may allocate each of the plurality of commands, which are fetched by the host manager 1120a, to one of the host DMA engines 1130a (S12). For example, the resource monitor 1160a may monitor a load of each of the host DMA engines 1130a, and based on a monitoring result by the resource monitor 1160a, the host queue manager 1170a may allocate a command to a host DMA engine that has a smallest load from among the host DMA engines 1130a.

Each of the host DMA engines 1130a may control a transfer of data via the host interface 1110a, according to each command (or an operation according to the command) that is allocated thereto (S13). For example, one of the host DMA engines 1130a may control to transmit data to the host interface 1110a, according to an allocated read command, and another one of the host DMA engines 1130a may control to receive data via the host interface 1110a, according to an allocated write command.

Each of the host DMA engines 1130a may check whether a command to be performed exists (S14). That is, after each of the host DMA engines 1130a completes an operation according to the allocated command, each of the host DMA engines 1130a may check whether there is a command that is additionally allocated thereto. At least one host DMA engine that is allocated to an additional command, from among the host DMA engines 1130a, may control a transfer of data via the host interface 1110a, according to the additional command allocated thereto (S13). The rest of the host DMA engines 1130a that are not allocated to an additional command may wait until a new command is allocated thereto by the host queue manager 1170a.

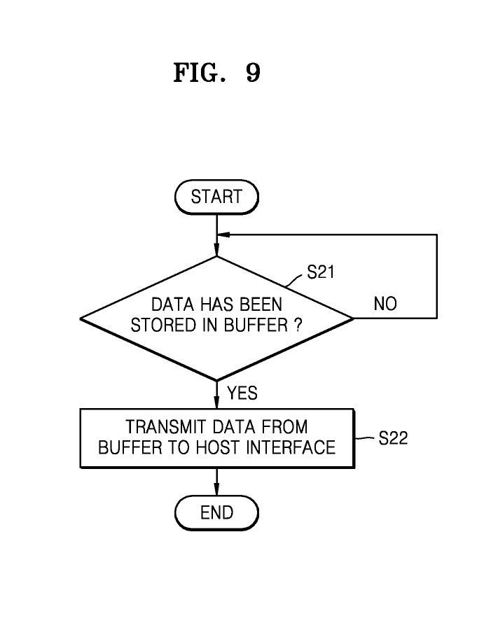

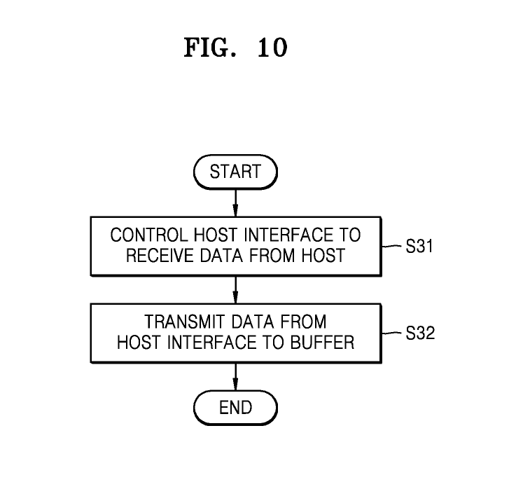

FIGS. 9 and 10 illustrate flowcharts showing operations of a host DMA engine, according to exemplary embodiments. In more detail, FIG. 9 illustrates a flowchart showing operations of the host DMA engine when a read command is allocated to the host DMA engine, and FIG. 10 illustrates a flowchart showing operations of the host DMA engine when a write command is allocated to the host DMA engine. The operations shown in FIGS. 9 and 10 may be performed by one host DMA engine, and a plurality of host DMA engines may perform, independently from each other, the operations show in FIGS. 9 and 10. The exemplary embodiments of FIGS. 9 and 10 are described with reference to the first host DMA engine 1130_1c of FIG. 5, but it is obvious that the exemplary embodiments of FIGS. 9 and 10 may also be applied to another host DMA engine included in the host DMA engines 1130c.

As illustrated in FIG. 9, the first host DMA engine 1130_1c may check whether data has been stored in the buffer 1190c by at least one of the memory DMA engines 1140_1, 1140_2, . . . , 1140_N (S21). For example, the buffer 1190c may include a descriptor indicating whether a data storing operation has been completed, and the first host DMA engine 1130_1c may check the descriptor included in the buffer 1190c. When the data is stored in the buffer 1190c, the first host DMA engine 1130_1c may transmit the data from the buffer 1190c to the host interface 1110c (S22).

As illustrated in FIG. 10, the first host DMA engine 1130_1c may control the host interface 1110c to receive data from the host 2000c (S31). For example, the first host DMA engine 1130_1c may control the host interface 1110c to receive data from one of sub-systems included in the host 2000c. The first host DMA engine 1130_1c may transmit the data from the host interface 1110c to the buffer 1190c (S32). The data temporarily stored in the buffer 1190c may be stored in the nonvolatile memory 1200c by at least one of the memory DMA engines 1140_1, 1140_2, . . . , 1140_N.

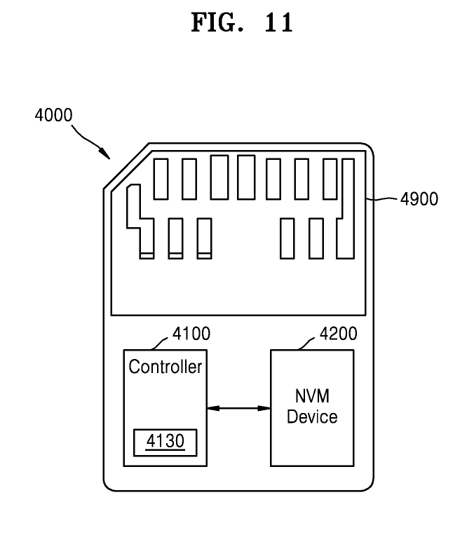

FIG. 11 illustrates a memory card 4000, according to an exemplary embodiment. The memory card 4000 is an example of a portable storage device that is used while connected to an electronic device such as a mobile device or a desktop computer. The memory card 4000 may communicate with a host by using various card protocols (e.g., a universal serial bus (USB) flash device (UFD), a multimedia card (MMC), a secure digital (SD) card, a mini SD, a micro SD, or the like).

As illustrated in FIG. 11, the memory card 4000 may include a controller 4100, a nonvolatile memory device 4200, and a port area 4900. The controller 4100 may include a plurality of host DMA engines 4130 and may perform operations of a memory controller in the aforementioned one or more exemplary embodiments. For example, the controller 4100 may include a host interface connected with the port area 4900, and the host DMA engines 4130 may control, independently from each other, a transfer of data via the host interface.

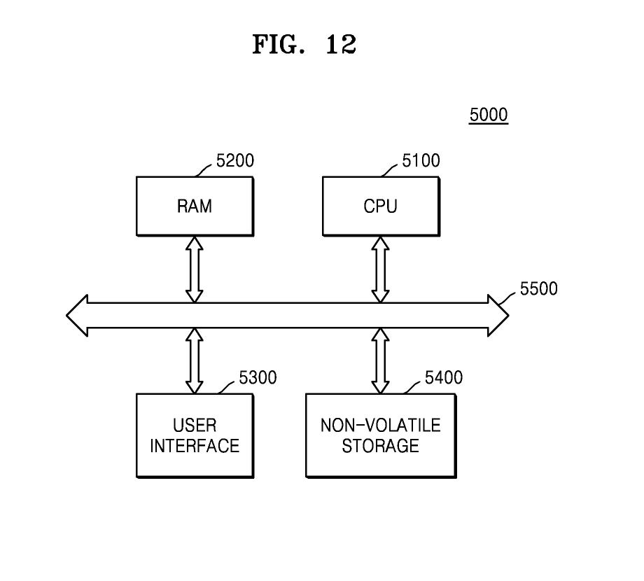

FIG. 12 illustrates a computing system 5000 including a nonvolatile storage 5400, according to an exemplary embodiment. A memory system according to the one or more exemplary embodiments may be mounted as the nonvolatile storage 5400 in the computing system 5000 such as a mobile device, a desktop computer, or a server.

The computing system 5000 according to an exemplary embodiment may include a central processing unit (CPU) 5100, a RAM 5200, a user interface 5300, and the nonvolatile storage 5400 that are connectable to a bus 5500. The CPU 5100 may generally control the computing system 5000 and may be an application processor (AP). The RAM 5200 may function as a data memory of the CPU 5100 and may be integrated with the CPU 5100 in one chip by, for example, system-on-chip (SoC) technology or package-on-package (PoP) technology. The user interface 5300 may receive an input of a user or may output a video signal and/or an audio signal to the user.

The memory system mounted as the nonvolatile storage 5400 may include a memory controller and a nonvolatile memory according to the one or more exemplary embodiments. For example, the memory controller may include a plurality of host DMA engines capable of independently controlling a transfer of data between the nonvolatile storage 5400 and another element such as the RAM 5200 connected to the bus 5500. Therefore, a time period needed to write data to the nonvolatile storage 5400 or to read data from the nonvolatile storage 5400 may be decreased.

Although some exemplary embodiments have been shown and described, it will be appreciated by those skilled in the art that changes may be made in these embodiments without departing from the principles and spirit of the inventive concept, the scope of which is defined in the appended claims and their equivalents.

What is claimed is:

1. A memory system comprising a memory and a memory controller configured to control the memory, wherein the memory controller comprises:
a first host interface connected to a host according to a bus standard;
a host manager configured to fetch a first set of commands from the host via the first host interface; and
a plurality of host direct memory access (DMA) engines,
wherein each of the plurality of host DMA engines controls a transfer of user data corresponding to one of the first set of commands via the first host interface.

2. The memory system of claim 1, wherein the memory controller further comprises a host queue manager configured to allocate a command included in the first set of commands to one of the plurality of host DMA engines.

3. The memory system of claim 2, wherein the memory controller further comprises a resource monitor configured to monitor a load of each of the plurality of host DMA engines, and
the host queue manager is configured to, based on a result of monitoring by the resource monitor, preferentially allocate the command included in the first set of commands to a host DMA engine that has a smallest load from among the plurality of host DMA engines.

4. The memory system of claim 2, wherein the memory controller further comprises a second host interface connected to the host according to the bus standard,
the host manager is configured to fetch a second set of commands from the host via the second host interface, and
each of the plurality of host DMA engines is configured to control a transfer of user data corresponding to one of the second set of commands via the second host interface.

5. The memory system of claim 4, wherein the host manager is configured to identify the one of the first set of commands by using a first identifier and identify the one of the second set of commands by using a second identifier.

6. The memory system of claim 1, wherein the memory controller further comprises a buffer configured to temporarily store the user data, and
the plurality of host DMA engines control, independently from each other, a transfer of the user data between the first host interface and the buffer.

7. The memory system of claim 6, wherein the first set of commands are read commands for reading the user data, and each of the plurality of host DMA engines are configured to determine whether the user data has been stored in the buffer, and transmit the user data stored in the buffer to the host via the first host interface in response to determining that the user data has been stored in the buffer.

8. The memory system of claim 6, wherein the first set of commands are write commands for writing the user data, and each of the plurality of host DMA engines are configured to control the first host interface to receive the user data from the host, and transmit the user data from the first host interface to the buffer.

9. The memory system of claim 6, wherein the memory comprises a plurality of memory devices each of which is connected to one of a plurality of channels,
the memory controller comprises a plurality of memory DMA engines that are connected to the plurality of channels, respectively, and
each of the plurality of memory DMA engines is configured to control a transfer of data between the buffer and at least one of the plurality of memory devices that is connected to the each of the plurality of memory DMA engines via a channel.

10. The memory system of claim 9, wherein the memory controller further comprises an internal bus to which the first host interface, the host manager, the plurality of host DMA engines, the buffer, and the plurality of memory DMA engines are connected.

11. The memory system of claim 1, wherein the bus standard is a peripheral component interconnect express (PCIe) standard.

12. A memory system comprising a memory and a memory controller configured to control the memory, wherein the memory controller is connected to a host according to a bus standard, configured to fetch, from the host, a plurality of commands arranged according to a first order, and configured to complete, according to a second order, a plurality of operations corresponding to the plurality of commands.

13. The memory system of claim 12, wherein, when each of the plurality of operations is completed, the memory controller is configured to transmit information about a command corresponding to a completed operation to the host.

14. The memory system of claim 12, wherein the memory controller comprises a plurality of host direct memory access (DMA) engines, each of which is allocated to one of the plurality of commands.

15. The memory system of claim 12, wherein the bus standard is a peripheral component interconnect express (PCIe) standard.

16. A memory controller for controlling a memory, the memory controller comprising:
a first host direct memory access (DMA) engine configured to control a transfer of first data in response to a command to write or read the first data to/from the memory; and
a second host DMA engine configured to control a transfer of second data in response to a command to write or read the second data to/from the memory such that the transfer of the second data is performed in parallel with the transfer of the first data.

17. The memory controller of claim 16, further comprising:
a host interface connected to a host according to a bus standard; and
a host manager configured to fetch a plurality of commands from the host via the host interface.

18. The memory controller of claim 17, further comprising:
a buffer configured to temporarily store the first data and the second data, and
wherein the first host DMA engine and the second host DMA engine may independently control the transfer of the first data and the transfer of the second data between the host interface and the buffer.

19. The memory controller of claim 16, further comprising:
a host queue manager configured to allocate a first command among a plurality of commands to the first DMA engine and allocate a second command among the plurality of commands to the second DMA engine.

20. The memory controller of claim 19, wherein an order in which the first command and the second command are arranged is different from an order in which the transfer of the first data and the transfer of the second data are completed by the first and second host DMA engines, respectively.
